(19) United States
(12) Patent Application Publication
(10) Pub. No.: US 2008/0303932 A1
(43) Pub. Date: Dec. 11, 2008

(54) ISOLATION STRUCTURE FOR IMAGE SENSOR DEVICE

(75) Inventors: Wen-De Wang, Chiayi County (TW); Jen-Cheng Liu, Hsin-Chu City (TW); Dun-Nian Yaung, Taipei City (TW); Chun-Chieh Chuang, Tainan City (TW); Jyh-Ming Hung, Changhua County (TW)

Correspondence Address: HAYNES AND BOONE, LLP, 901 Main Street, Suite 3100, Dallas, TX, 75202, US

(73) Assignee: TAIWAN SEMICONDUCTOR MANUFACTURING COMPANY, LTD, Hsin-Chu (TW)

(21) Appl. No.: 12/120,019

(22) Filed: May 13, 2008

Related U.S. Application Data
(60) Provisional application No. 60/943,184, filed on Jun. 11, 2007.

(51) Int. Cl. H04N 5/335

(52) U.S. Cl. 348/308; 348/294; 348/302; 348/E05.091

(57) ABSTRACT

Provided is an image sensor device including a substrate with a pixel region and a peripheral region. A first isolation structure is formed on the substrate in the pixel region. The first isolation structure includes a trench having a first depth. A second isolation structure is formed on the substrate in the peripheral region. The second isolation structure includes a trench having a second depth. The first depth is greater than the second depth.

### PRIORITY DATA

This application claims the priority under 35 U.S.C. §119 of U.S. Provisional Application Ser. No. 60/943,184 filed on Jun. 11, 2007, which is hereby incorporated herein by reference.

### BACKGROUND

The present disclosure relates generally to image sensors and, more particularly, to image sensors including integrated circuits, such as complementary metal-oxide semiconductor (CMOS) image sensors and charge coupled device (CCD) image sensors.

In semiconductor technologies, image sensors are used for sensing a volume of exposed light projected towards the semiconductor substrate. Both CMOS image sensors and CCD image sensors are widely used in various applications such as digital cameras. These image sensors use an array of pixels that include light sensitive elements to collect photo energy to convert images into digital data. However, as pixels are scaled down, the sensitivity of a pixel tends to decrease. In addition, there is increased crosstalk between pixels. Crosstalk may degrade the spatial resolution, reduce overall sensitivity, provide for poor color separation, and may lead to additional noise in the image, in particular after a color correction procedure. Processes including those requiring thinner layers of material (e.g. thin dielectric and metal layers) and thin color filters may be utilized to improve the optical crosstalk. However, these conventional methods of improving electrical crosstalk, such as providing a sensor with a thin epitaxial layer, provide for additional issues such as electrostatic discharge (ESD) failures. Further issues with conventional image sensors include long wavelength light sensitivity and image defects such as from blooming effects (e.g. certain areas of the output image appearing brighter than the original image.)

As such, an improved image sensor is desired.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a top view of an image sensor including a pixel region and a peripheral region.

FIG. 2 is a cross-sectional view illustrating a conventional image sensor including an array of pixels and a peripheral region.

FIG. 3 is a cross-sectional view illustrating an embodiment of an image sensor including an array of pixels and a peripheral region.

FIG. 4 is a flow chart illustrating an embodiment of a method of fabricating the image sensor of FIG. 3.

FIGS. 5a-5g are cross-sectional views illustrating an embodiment of the method of FIG. 4.

FIG. 6 is a flow chart illustrating an alternative embodiment of a method of fabricating the image sensor of FIG. 3.

FIGS. 7a-7e are cross-sectional views illustrating an embodiment of the method of FIG. 5.

FIG. 8 is a cross-sectional view of an alternative embodiment of an image sensor including an array of pixels and a peripheral region.

### DETAILED DESCRIPTION

The present disclosure relates generally to semiconductor devices and more particularly, to image sensors. It is understood, however, that specific embodiments are provided as examples to teach the broader inventive concept, and one of ordinary skill in the art can easily apply the teaching of the present disclosure to other methods or devices. In addition, it is understood that the methods and apparatus discussed in the present disclosure include some conventional structures and/or processes. Since these structures and processes are well known in the art, they will only be discussed in a general level of detail. Furthermore, reference numbers are repeated throughout the drawings for sake of convenience and example, and such repetition does not indicate any required combination of features or steps throughout the drawings. Moreover, the formation of a first feature over, on, or coupled to a second feature in the description that follows may include embodiments in which the first and second features are formed in direct contact, and may also include embodiments in which additional features may be formed interposing the first and second features, such that the first and second features may not be in direct contact. Also, the formation of a feature on a substrate, or on a surface of a substrate, may include embodiments where features are formed above the surface of the substrate, adjacent to the surface of the substrate, directly on the surface of the substrate, and/or extending below the surface of the substrate (such as implanted regions, trenches).

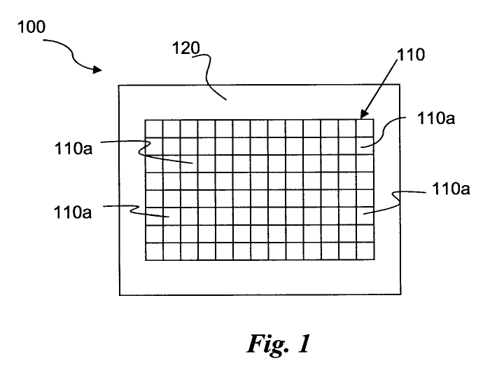

Referring to FIG. 1, an image sensor device 100 provides a pixel region 110 and a peripheral region 120. The pixel region 110 includes an array of pixels 110a. In an embodiment, the image sensor device 100 may be a complimentary metal oxide semiconductor (CMOS) image sensor (CIS) or active pixel sensor. In an alternative embodiment, the image sensor device 100 may be a charge coupled device (CCD) sensor. The image sensor device 100 may be a front-side illuminated sensor or a back-side illuminated sensor. In a back-side illuminated sensor configuration, the light to be sensed is incident on the back-side of a substrate, while the pixels are formed on the front side of the substrate. The pixels 110a include at least one photodetector (e.g. photodiode) for recording an intensity or brightness of light. In an embodiment, the pixels 110a include a pinned photodiode. Each of the pixels 110a also includes at least one transistor. The pixels 110a may include a reset transistor, a source follower transistors, a selector transistor, and/or a transfer transistor. The reset transistor may act to reset the pixels 110a. The source follower transistor may allow a voltage associated with the pixels 110a to be observed without removing the accumulated charge. The selector transistor may be a row-select transistor and allow a single row of pixels 110a to be read when the selector transistor is turned on. A transfer transistor may move a charge accumulated in a photodetector of the pixels 110a to another device and thus data output from the pixel. A transfer transistor may allow for correlated double sampling. In one embodiment, a transfer transistor may be associated with (e.g. assigned to) a single photodiode, while a source follower, reset, and selector transistor may be associated with (e.g. shared by) a plurality of photodiodes. In a second embodiment, a transfer transistor may be associated with one photodiode, while a source follower and reset transistor may be associated with a plurality of photodiodes. In an embodiment, the pixels 110 include four (4) transistors each; one such image sensor element is known in the art as 4T CMOS image sensor. The 4T CMOS image sensor may include a transfer transistor, a reset transistor, a source follower transistor, and a selector transistor. In an embodiment, a transistor included in the pixel region 110 includes a metal-oxide-semiconductor field effect transistor (MOSFET) having a gate that includes a silicide layer. The silicide may include a silicide, such as nickel silicide, cobalt silicide, tungsten silicide, tantalum silicide, titanium silicide, platinum silicide, erbium silicide, palladium silicide, and/or combinations thereof.

In the peripheral region 120, additional circuitry and input/outputs are provided adjacent to the pixel region 110 for providing an operation environment for the pixels 110a and/or for supporting external communications with the pixels 110a. The peripheral region 120 may also be known as a logic region as it may include logic circuitry associated with the pixels 110a. The peripheral region 120 may include a low power logic circuit. The low-power logic circuit may include a low power, high-speed, high-performance logic circuit. The peripheral region 120 may include circuits for example, to drive the pixels in order, to obtain signal charges, A/D converters, processing circuits for forming image output signals, electrical connections operable for connecting to other devices, and/or other components known in the art. In an embodiment, the peripheral region 120 includes a MOSFET device having a source, drain, and gate electrode, all including a silicide layer. The silicide may include a silicide, such as nickel silicide, cobalt silicide, tungsten silicide, tantalum silicide, titanium silicide, platinum silicide, erbium silicide, palladium silicide, and/or combinations thereof.

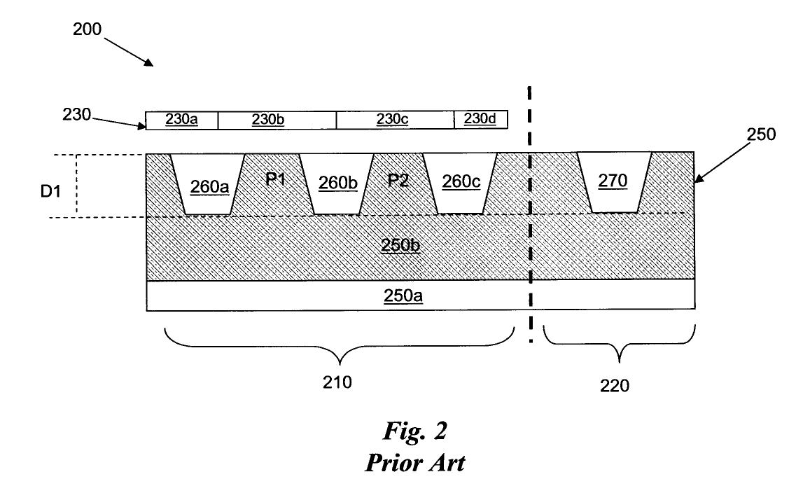

Referring now to FIG. 2, illustrated is a cross-sectional view of a conventional image sensor 200. The sensor 200 includes a pixel region 210 and a peripheral region 220. A color filter 230 is positioned over the pixel region 210. The color filer 230 has multiple filters including a blue light filter 230a, a green light filter 230b, a red light filter 230c, and a blue light filter 230d. The sensor 200 includes a substrate 250 having a sub layer 250a and an epitaxial layer 250b. A plurality of trenches including trenches 260a, 260b, 260c, and 270 are formed on the substrate 250. The trenches 260a, 260b, and 260c are formed in the pixel region 210. The trench 270 is formed in the peripheral region 220. The trench 270 is substantially similar to the trenches 260a, 260b, and 260c. For example, the trench 270 is substantially the same depth D1 as the trenches 260a, 260b, and 260c. Typically, D1 is between 0.3 μm and 0.6 μm.

The trenches in the pixel region, including 260a, 260b, and 260c, serve to separate one pixel from a second pixel. For instance, the trench 260b serves to separate a pixel formed in the substrate 250 under the red light filter 230c, illustrated as region P2, from a pixel formed in the substrate under green light filter 230b, illustrated as region P1. The trench 270 may serve to separate one or more components in the peripheral circuit. The device 200 has disadvantages in that the trenches 260a, 260b, and/or 260c may not adequately isolate one pixel area from another. The depth of the trench 260a, 260b, and/or 260c may not be sufficient to keep a photo-generated carrier from a first pixel region, such as region P1, from moving to a second pixel region, such as region P2. This can cause electrical crosstalk and degrade the performance of the sensor 200. As such, an improved isolation structure is desired.

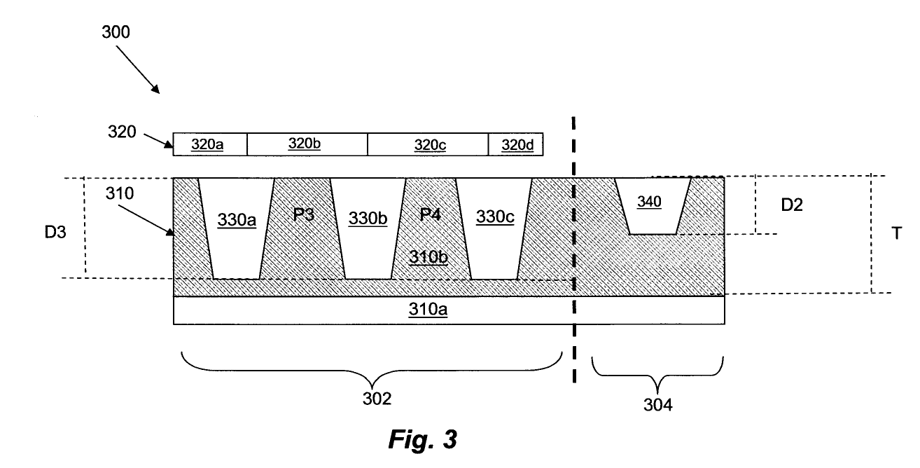

Referring now to FIG. 3, an image sensor device 300 according an embodiment of this invention is illustrated. The image sensor 300 includes a substrate 310, including a sub layer 310a and an epi layer 310b, and a color filter 320 overlying the substrate 310. The image sensor device 300 may be substantially similar to the image sensor device 100, described above with reference to FIG. 1. The image sensor device 300 includes a pixel region 302 and a peripheral region 304. A plurality of pixels (not illustrated) may be formed in the pixel region 302 of the substrate 310. By way of example, a first pixel may be formed in region P3 and a second pixel may be formed in the region P4. The pixels include a photodetector and one or more transistors. One or more of the plurality of pixels of the image sensor device 300 may be substantially similar to the pixels 110a, described above with reference to FIG. 1. The peripheral region 304 may be substantially similar to the peripheral region 120, also described above with reference to FIG. 1.

The color filter 320 includes blue light filters 320a and 320d, a green light filter 320b, and a red light filter 320c, though other embodiments of color filters are possible. In an alternative embodiment, the image sensor device 300 is a back-side illuminated sensor. In the embodiment, the color filter 320 is located adjacent the back surface of the substrate 310 and filters light incident the back-side of the substrate 310. Adjacent the color filter 320, opposite the substrate 310, one or more micro lenses (not illustrated) may be formed.

The substrate 310 may be silicon in a crystalline structure. In alternative embodiments, the substrate 310 may include other elementary semiconductors such as germanium, or include a compound semiconductor such as, silicon carbide, gallium arsenide, indium arsenide, and indium phosphide. In an embodiment, the substrate 310 is a P-type substrate (P-type conductivity) (e.g. a substrate doped with p− type dopants, such as boron or aluminum, by conventional processes such as diffusion or ion implantation). In other embodiments, the substrate 310 may include a P+ substrate, N+ substrate, and/or other conductivities known in the art. The substrate 310 may include a silicon on insulator (SOI) substrate. The epi layer 310b allows for a different doping profile than other portions of the substrate 310, including the sub layer 310a. The epi layer 310b may be grown on the substrate 310 using conventional methods. In an embodiment, the epi layer 310b is a p− epi layer. In an embodiment, the sub layer 310a is a p+ layer. In possible embodiments include, the epi layer 310b being N− epi layer and the sub layer 310a being a N+ sub layer, the epi layer 310b being a N− epi layer and the sub layer 310a being a P+ sub layer, and/or other conductivities known in the art. The thickness T of the epi layer 310b may be between approximately 2 μm and 10 μm. In a further embodiment, the thickness T of the epi layer may be approximately 4 μm.

In an embodiment, the epi layer 310b has p− type conductivity and the photodiode included in the pixels (not shown) formed on the substrate 310 includes a photodetector including an N-type photogeneration region (e.g. an N-type well formed in a P− epitaxial layer). The N-type photogeneration region may be formed by doping the substrate with an N-type dopant such as phosphorous, arsenic, and/or other N-type dopant known in the art. The doping may be accomplished by conventional processes known in the art such as photolithography patterning followed by ion implantation or diffusion. In a further embodiment, the photodetector includes a pinned photodiode. The pinned layer may be doped with a p− type dopant. The P-type dopant may include boron, aluminum, and/or other dopants known in the art giving P-type conductivity.

An isolation structure, including an isolation trench 340, is formed in the peripheral region 304 of the image sensor 300. The isolation trench 340 may include a shallow trench isolation (STI) structure. The isolation trench 340 may assist in isolating one or more components formed in the peripheral region 304. The isolation trench 340 has a depth D2 less than approximately 0.6 μm. In an embodiment, the isolation trench 340 has a depth D2 between approximately 0.3 μm and 0.6 μm. An increased depth D2 (e.g. greater than 0.6 μm) may provide for a high sheet resistance (Rs) of the N-Well junction present in the peripheral region 304. The greater Rs may degrade the “pick-up” function. The isolation trench 340 may include silicon oxide. In an embodiment, the isolation trench 340 may include air in addition to or in lieu of silicon oxide. Other embodiments, including those in which the trench 340 includes other insulating materials, are possible. The isolation trench 340 may be formed using conventional processes known in the art. For example, apertures may be etched in the substrate 310 in the peripheral region 304 using conventional processes such as reactive ion etch (RIE) according to a pattern formed by conventional photolithography processes. The apertures may then be filled. For example, in an embodiment, the trenches are filled with silicon oxide. In an embodiment, the process includes high density plasma chemical vapor deposition (HDPCVD) of silicon oxide to fill an aperture, and continues with a chemical-mechanical polish (CMP) process to planarize the oxide. In an alternative embodiment, the process includes a sub-atmospheric chemical vapor deposition (SACVD) of silicon oxide, and continues with a CMP process to planarize the oxide. Methods of forming the isolation trench 340 are discussed in greater detail below.

A plurality of isolation structures including isolation trenches 330a, 330b, and 330c, are formed in the pixel region 302 of the substrate 310. The isolation trenches 330a, 330b, and/or 330c may include shallow trench isolation (STI) structures. The isolation trenches 330a, 330b, and/or 330c at least partially isolate one pixel from a second pixel in the pixel region 302. For example, the isolation trench 330b provides for minority carriers to be blocked from traveling from pixel region P3 to pixel region P4. The isolation trenches 330a, 330b, and/or 330c have a depth D3 greater than approximately 0.6 μm. In an embodiment, the isolation trenches 330a, 330b, and/or 330c may have a depth D3 between approximately 0.6 μm and 2 μm. In an embodiment, the isolation trenches 330a, 330b, and/or 330c may have a depth D3 between approximately 0.6 μm and 1 μm. In an embodiment, the isolation trenches 330a, 330b, and/or 330c may have a depth D3 between approximately 1 μm and 2 μm.

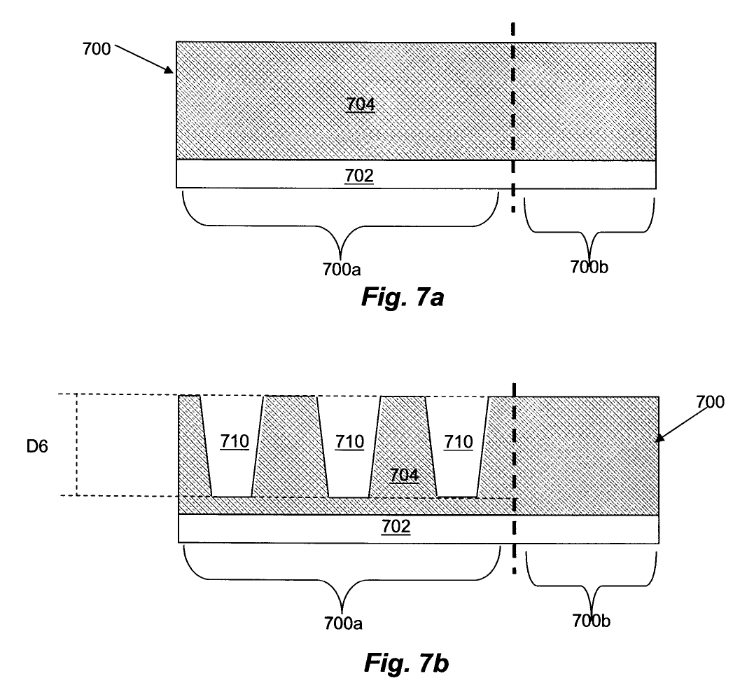

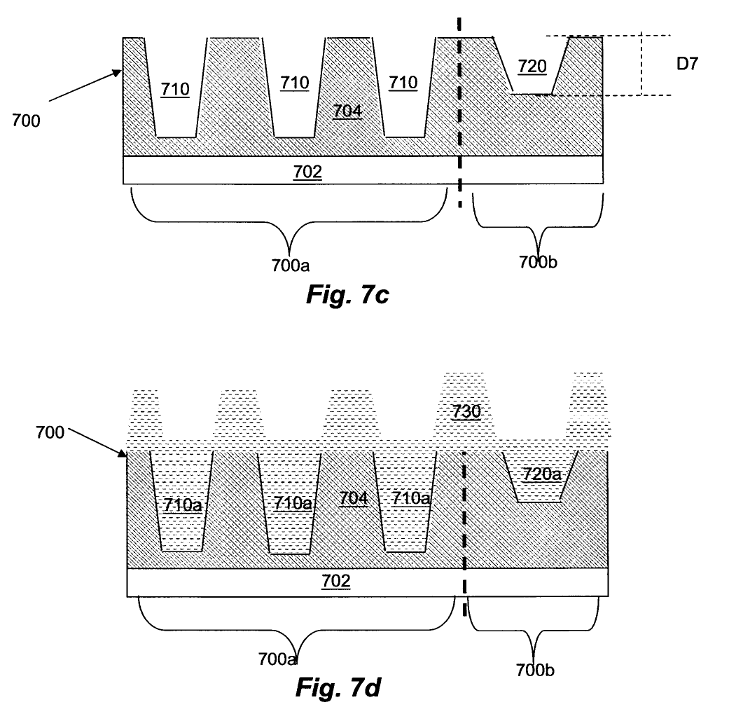

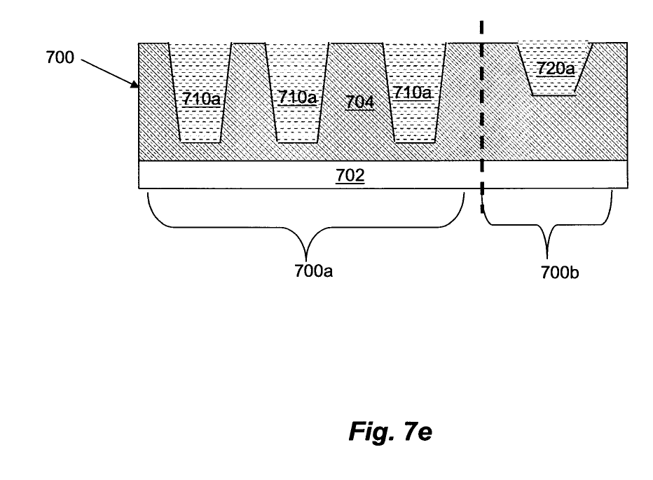

The isolation trenches 330a, 330b, and/or 330c may include (e.g. are filled with in entirety or in part with) insulating material. The insulating material, such as silicon oxide, may isolate the minority carriers from traveling from one pixel to a second pixel. In an alternative embodiments, the isolation trenches 330a, 330b, and/or 330c may be filled with oxide, a substantially optically opaque material, and/or a low refractive index material, as described below in greater detail with reference to FIG. 7. The isolation trenches 330a, 330b, and/or 330c may be formed using conventional processes known in the art. For example, apertures may be etched in the pixel region 302 of the substrate 310 using conventional processes such as RIE after patterning by conventional photolithography processes. The apertures may then be filled, for example, in an embodiment, the trenches are filled with silicon oxide. In an embodiment, the process includes high density plasma chemical vapor deposition (HDPCVD) of silicon oxide to fill an aperture, and continues with a chemical-mechanical polish (CMP) process to planarize the oxide. In an alternative embodiment, the process includes a sub-atmospheric chemical vapor deposition (SACVD) of silicon oxide, and continues with a CMP process to planarize the oxide. Methods of forming the isolation trenches 330a, 330b, and 330c are discussed in greater detail below.

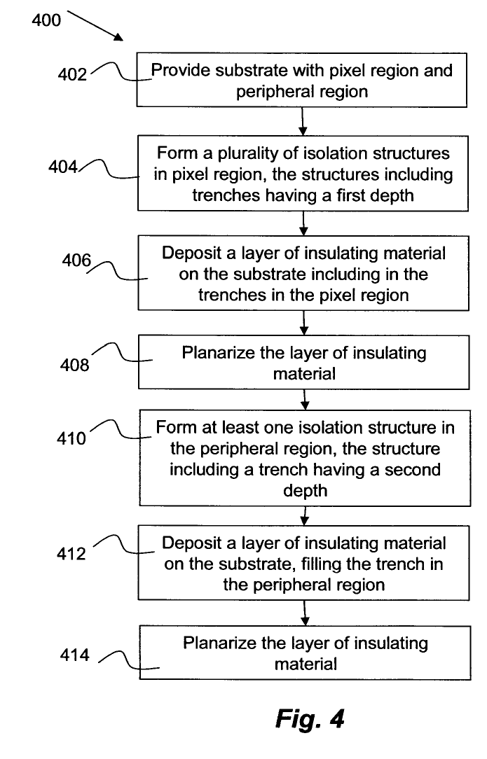

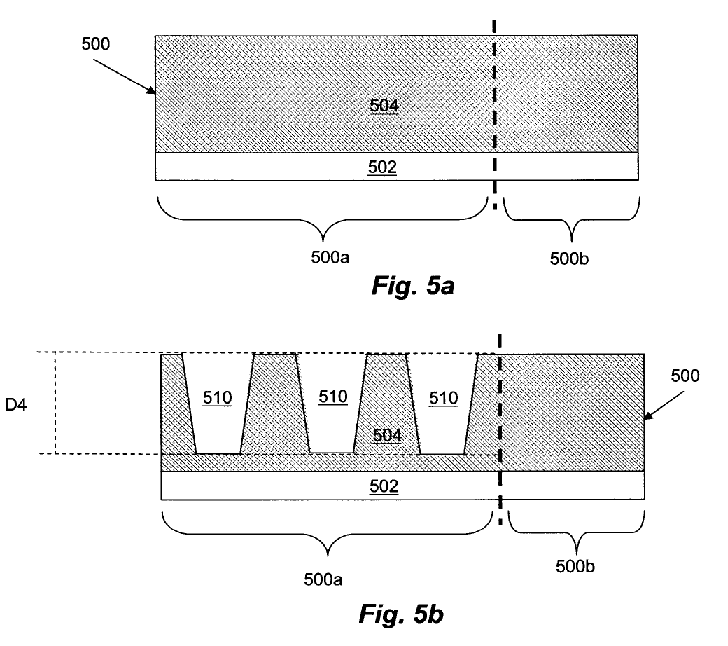

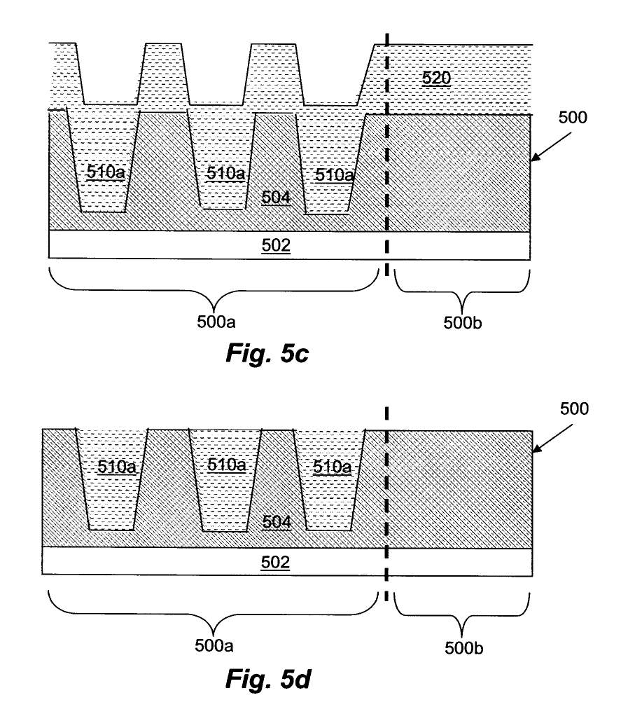

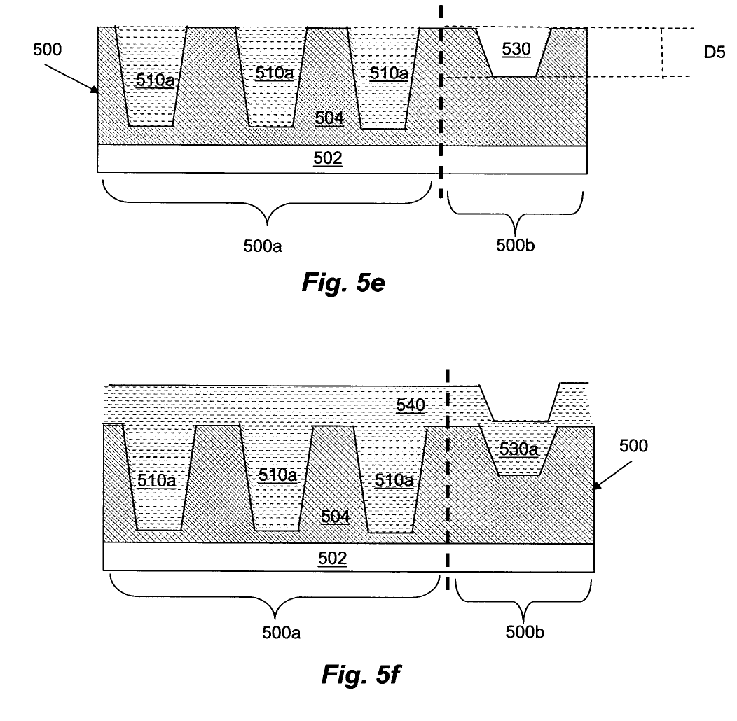

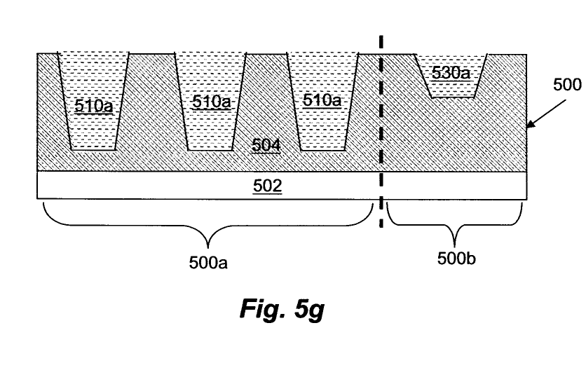

FIG. 4 illustrates a method 400 of forming an image sensor including isolation structures; FIGS. 5a, 5b, 5c, 5d, 5e, and 5f illustrate incremental modifications of a substrate 400 that correspond to the steps of FIG. 4. The method 400 may be used to fabricate an image sensor device substantially similar to the image sensor 300, described above with reference to FIG. 3.

The method 400 begins at step 402 where a substrate having a pixel region and a peripheral region is provided. The substrate also includes an epitaxial layer. The substrate provided may be substantially similar to the substrate 310, described above in reference to FIG. 3. In the example of FIG. 5a, the substrate 500 is provided. The substrate 500 includes a sub layer 502 and an epitaxial (epi) layer 504. In an embodiment, the sub layer 502 is a P+ layer and the epi layer 504 may be a P− layer. The substrate 500 further includes a pixel region 500a and a peripheral region 500b. The pixel region 500a may be substantially similar to the pixel region 110 and/or the pixel region 302, described above with reference to FIG. 1 and FIG. 3 respectively. The peripheral region 500b may be substantially similar to the peripheral region 120 and/or the peripheral region 304, also described above with reference to FIG. 1 and FIG. 3 respectively.

The method 400 then proceeds to step 404 where a plurality of isolation structures are formed in the pixel region of the substrate. The isolations structures include isolation trenches. The trenches may be formed to a depth greater than approximately 0.6 μm. The trenches may be formed by processes known in the art such as photolithography patterning followed by RIE to form apertures (trenches) in the patterned areas. In the example of FIG. 5b, trenches 510 are etched in the substrate 500 and in particular in the epi layer 504 of the substrate 500. The trenches 510 are etched to a depth D4. D4 may be between approximately 0.6 μm and 2 μm.

The method 400 proceeds to step 406 where a layer of insulating material is formed on the substrate. The layer may be formed by depositing material using chemical vapor deposition (CVD), plasma-enhanced chemical vapor deposition (PECVD), atmospheric pressure chemical vapor deposition (APCVD), low-pressure CVD (LPCVD), high density plasma CVD (HDPCVD), atomic layer CVD (ALCVD), sub-atmospheric CVD (SACVD), and/or other processes known in the art. In an embodiment, the insulating material is silicon oxide. In an embodiment, the oxide is deposited by either HDPCVD or SACVD. The layer may fill, partially or entirely, a trench formed in the pixel region, described above in reference to step 404. In the example of FIG. 5c, a conformal insulating layer 520 is deposited on the substrate 500. The insulating layer 520 fills the trenches 510, now designated as isolation trenches 510a. The method then proceeds to step 408 where the insulating layer is planarized. In an embodiment, the layer is planarized by a chemical mechanical polish (CMP) process. In the example of FIG. 5d, illustrated is the planarized insulating layer 520 such that the insulating material completely fills the isolation trenches 510a and a substantially planar surface of the substrate 500 is provided.

The method 400 proceeds to step 410 where at least one isolation structure is formed in the peripheral region of the substrate. The isolation structure includes an isolation trench. A trench is etched to a depth that is less than the depth of the trenches formed in the pixel region, described above in reference to step 404. The trench may be etched to a depth less than approximately 0.6 μm. The trench may be etched by processes known in the art such as photolithography patterning followed by RIE to form an aperture (trench) according to the patterned area. In the example of FIG. 5e, the trench 530 is etched in the peripheral region 500b of the substrate 500, in particular in the epi region 504 of the substrate 500. The trench 530 is etched to a depth D5. The depth D5 is less than the depth D4, described above in reference to FIG. 5b. In an embodiment, the depth D5 is less than approximately 0.6 μm. The method 400 proceeds to step 412 where a conformal layer of insulating material is deposited on the substrate. The layer may fill, completely or partially, the trench formed in the peripheral region, as described above with reference to step 410. The insulating material may be deposited by physical vapor deposition (PVD) (sputtering), chemical vapor deposition (CVD), plasma-enhanced chemical vapor deposition (PECVD), atmospheric pressure chemical vapor deposition (APCVD), low-pressure CVD (LPCVD), high density plasma CVD (HDPCVD), atomic layer CVD (ALCVD), sub-atmospheric CVD (SACVD), and/or other processes known in the art. In an embodiment, the insulating material includes silicon oxide. In a further embodiment, the oxide is deposited by either HDPCVD or SACVD. In the example of FIG. 5f, a conformal layer of insulating material 540 is deposited on the substrate 500, including filling the trench 530. The method 400 proceeds to step 414 where the insulating layer is planarized. In an embodiment, the insulating layer is planarized by a chemical mechanical polish (CMP) process. In the example of FIG. 5g, illustrated is the planarized insulating layer 540 such that the insulating material fills the trench 530 and a substantially planar surface of the substrate 500 is provided. In an embodiment, the insulating layer 540 includes silicon oxide.

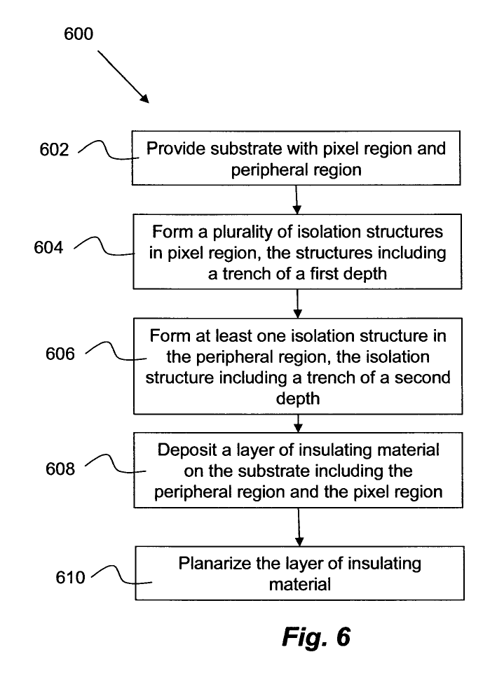

Referring now to FIG. 6, illustrated is a method 600 for fabricating an image sensor device; FIGS. 7a, 7b, 7c, 7d, and 7e illustrate incremental modifications of a substrate 700 that correspond to the steps of FIG. 6. The method 600 may be used to fabricate an image sensor device substantially similar to the image sensor 300, described above with reference to FIG. 3.

The method 600 begins at step 602 where a substrate having a pixel region and a peripheral region is provided. The substrate also includes an epitaxial layer. The substrate provided may be substantially similar to the substrate 310, described above in reference to FIG. 3. In the example of FIG. 7a, the substrate 700 is provided. The substrate 700 includes a sub layer 702 and an epitaxial (epi) layer 704. In an embodiment, the sub layer 702 is a P+ layer and the epi layer 704 is a P− layer. The substrate 700 further includes a pixel region 700a and a peripheral region 700b. The pixel region 700a may be substantially similar to the pixel region 110 and/or the pixel region 302, described above with reference to FIG. 1 and FIG. 3 respectively. The peripheral region 700b may be substantially similar to the peripheral region 120 and/or the peripheral region 304, also described above with reference to FIG. 1 and FIG. 3 respectively.

The method 600 then proceeds to step 604 where a plurality of isolation structures are formed in the pixel region of the substrate. The isolation structures include isolation trenches. The trenches may be formed in the substrate to a depth greater than 0.6 μm. The trenches may be formed by processes known in the art such as photolithography patterning followed by RIE to form an aperture (trench) according to the patterning. In the example of FIG. 7b, trenches 710 are etched in the substrate 700, in particular in the epi layer 704 of the substrate 700. The trenches 710 are etched to a depth D6. The depth D6 is greater than 0.6 μm. In an embodiment, D6 is between approximately 0.6 μm and 2 μm.

The method 600 proceeds to step 606 where at least one isolation structure is formed in the peripheral region of the substrate. The isolation structure includes an isolation trench. The trench may be formed with a depth less than 0.6 μm. The trench is formed with a depth less than that of the trench(es) formed in the pixel region of the substrate, described above with reference to step 604. The trench may be formed by processes known in the art such as photolithography patterning followed by RIE of an aperture (trench) according to the patterned area. In the example of FIG. 7c, the trench 770 is formed in the peripheral region 700b of the substrate 700. The trench 770 has a depth D7. The depth D7 is less than the depth D6, described above with reference to FIG. 7b. D7 may be less than 0.6 μm.

The method 600 proceeds to step 608 where a layer of insulating material is formed on the substrate. The layer may be formed by conventional deposition processes such as, chemical vapor deposition (CVD), plasma-enhanced chemical vapor deposition (PECVD), atmospheric pressure chemical vapor deposition (APCVD), low-pressure CVD (LPCVD), high density plasma CVD (HDPCVD), atomic layer CVD (ALCVD), SACVD, and/or other processes known in the art. In an embodiment, a layer of silicon oxide is formed on the substrate which may be deposited, for example, by HDPCVD or SACVD. The layer of insulating material at fills, completely or partially, the trenches formed in the peripheral region and the pixel region, described above with reference to steps 606 and 604 respectively. In the example of FIG. 7d, a conformal layer 730 including an insulating material is deposited on the substrate 700, including filling the trenches 710 and 720, now noted as isolation trenches 710a and 720a. In an embodiment, the layer 730 includes silicon oxide. The method 600 proceeds to step 610 where the insulating layer is planarized. In an embodiment, the insulating layer is planarized by a CMP process. In the example of FIG. 7e, illustrated is the planarized insulating layer 540 such that the trench 710a and 720b are filled and a substantially planar surface of the substrate 700 is provided.

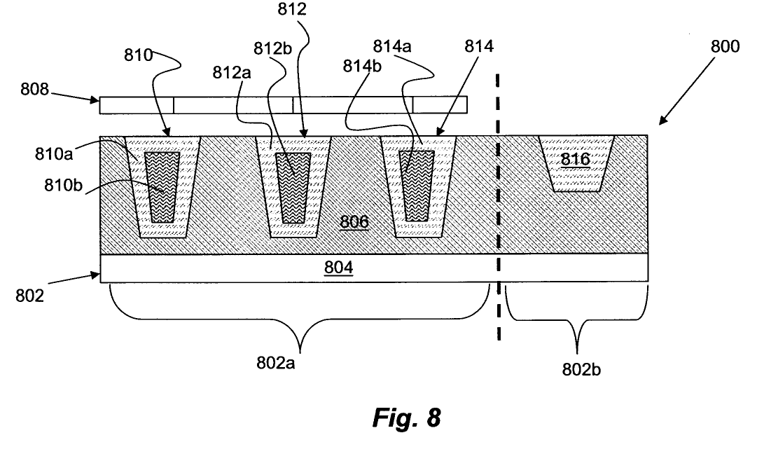

Referring now to FIG. 8, an image sensor 800 is illustrated. The image sensor 800 includes a substrate 802, including a sub layer 804 and an epitaxial (epi) layer 806, and a color filter 808 overlying the substrate 802. The image device 800 has a pixel region 802a and a peripheral region 802b. The image sensor 800 may be substantially similar to the image sensor device 300 and/or the image sensor 100, described above with reference to FIG. 3 and FIG. 1 respectively. Including, for example, the substrate 802 may be substantially similar to the substrate 310 described above with reference to FIG. 3; the peripheral region 802 may be substantially similar to the peripheral region 120 and/or the peripheral region 304, described above with reference to FIG. 1 and FIG. 3 respectively; the color filter 808 may be substantially similar to the color filter 320, described above with reference to FIG. 3. A plurality of pixels (not illustrated) may be formed in the pixel region 802a of the substrate 800. One or more of the plurality of pixels formed on the substrate 802 may be substantially similar to the pixels 110a, described above with reference to FIG. 1.

An isolation structure, including an isolation trench 816, is formed in the peripheral region 802b of the image sensor 800. The isolation trench 816 may be substantially similar to the isolation trench 340 described above in reference to FIG. 3. A plurality of isolation structures, including isolation trenches 810, 812, and 814 may be formed in the pixel region 802a of the image sensor 800. The isolation trenches 810, 812, and/or 814 may include STI structures. The isolation trenches 810, 812, and/or 814 provide increased isolation of one pixel from a second pixel in the pixel region 802a. The isolation trenches 810, 812, and/or 814 have a depth greater than the isolation trench 816. In an embodiment, the isolation trenches 810, 812, and/or 814 include a depth greater than 0.6 μm and the isolation trench 816 includes a depth less than 0.6 μm.

The isolation trenches 810, 812, and/or 814 may be filled with one or more types of material. The isolation trench 810 includes a first layer 810a and a second layer 810b, the isolation trench 812 includes a first layer 812a and a second layer 812b, and the isolation trench 814 includes a first layer 814a and a second layer 814b. The first layer 810a, 812a, and/or 814a of the isolation trenches may include a layer of insulating material. The insulating material, such as silicon oxide, may assist to isolate the minority carriers from traveling from one pixel to a second pixel. In an embodiment, the second layer 810b, 812b, and/or 814b of the isolation trenches includes a layer of substantially optically opaque material. In an embodiment, the substantially optically opaque material is greater than approximately 50% opaque. An example of substantially optically opaque material that may be included is tungsten and/or other opaque materials including other metal films. The use of a substantially optically opaque material may increase the image sensor 800 sensitivity to long wavelengths of light. In an alternative embodiment, the second layer 810b, 812b, and/or 814b includes a layer of low refractive index (RI) material, such as air. In an embodiment, the low RI material includes a RI of less than approximately 5. In an embodiment, the second layer 810b, 812b, and 814b includes an air gap in the first layer 810a, 812a, and 814a of insulating material. The inclusion of a low RI material may allow for additional reflection of incident light. The above described embodiments are illustrative only and not intended to be limiting. Other configurations and combinations of material are possible.

Thus provided is an image sensor device. The device includes a substrate including a pixel region and a peripheral region. An isolation structure is formed in the pixel region of the substrate. The isolation structure includes a trench. Another isolation structure is formed in the peripheral region of the substrate. This isolation structure also includes a trench. The trench formed in the pixel region has a greater depth than the trench formed in the pixel region.

Also provided is an additional image sensor device. The device includes a substrate including a pixel region and a peripheral region. A plurality of pixels are formed on the substrate in the pixel region. Between two pixels a trench is formed. The trench has a first depth. A second trench is formed in the peripheral region of the substrate. The second trench has a depth less than the first depth.

Also provided is a method of forming an image sensor. A substrate is provided that includes a pixel region and a peripheral region. A first isolation trench is formed in the pixel region of the substrate. The forming of the first isolation trench includes etching the substrate to a first depth. A second isolation trench is formed in the peripheral region of the substrate. The forming of the second isolation trench includes etching the substrate to a second depth. The second depth is less than the first depth.

Although only a few exemplary embodiments of this invention have been described in detail above, those skilled in the art will readily appreciate that many modifications are possible in the exemplary embodiments without material departing from the novel teachings and advantages of this disclosure.

What is claimed is:

1. An image sensor device comprising:
a substrate comprising a pixel region and a peripheral region;
a first isolation structure formed on the substrate in the pixel region, wherein the first isolation structure includes a first trench having a first depth; and
a second isolation structure formed on the substrate in the peripheral region, wherein the second isolation structure includes a second trench having a second depth, and wherein the first depth is greater than the second depth.

2. The device of claim 1, wherein the first isolation structure includes silicon oxide.

3. The device of claim 1, wherein the first isolation structure includes material selected from the group consisting of an insulating material, a substantially optically opaque material, a low refractive index material, and combinations thereof.

4. The device of claim 1, wherein the first depth is greater than approximately 0.6 μm.

5. The device of claim 1, wherein the substrate comprises an epitaxial layer having a first type of conductivity and a substrate layer having a second type of conductivity.

6. The device of claim 5, wherein the substrate is selected from the group consisting of a substrate having the first type of conductivity including p− type and the second type of conductivity including p+ type, a substrate having the first type of conductivity including n− type and the second type of conductivity including n+ type, and a substrate having the first type of conductivity including n− type and the second type of conductivity including p+ type.

7. The device of claim 1, further comprising:
a color filter located adjacent the substrate.

8. The device of claim 1, wherein the substrate has a front surface and a back surface, and wherein a plurality of color filters are located adjacent the back surface of the substrate.

9. An image sensor device comprising:
a substrate having a pixel region and a peripheral region;
a first pixel and a second pixel formed on the substrate in the pixel region;
a first trench isolation structure formed in the pixel region of the substrate and located between the first pixel and the second pixel, wherein the first trench isolation structure has a first depth; and
a second trench isolation structure formed in the peripheral region, wherein the second trench isolation structure has a second depth, the second depth being less than the first depth.

10. The device of claim 9, wherein the substrate includes an epitaxial layer including a first-type of conductivity, and wherein the first pixel includes a photodiode including a second-type of conductivity.

11. The device of claim 9, wherein the first trench isolation structure includes silicon dioxide.

12. The device of claim 9, wherein the first trench isolation structure includes a low refractive index material.

13. The device of claim 9, wherein the first trench isolation structure includes a substantially optically opaque material.

14. The device of claim 9, wherein the first pixel comprises a photodiode and at least one transistor.

15. The device of claim 9, wherein the first pixel comprises a transfer transistor, a reset transistor, a source follower transistor, and a select transistor.

16. The device of claim 9, wherein the first pixel includes a first transfer transistor and a first photodiode and the second pixel includes a second transfer transistor and a second photodiode, and wherein a source follower transistor, a reset transistor, and a select transistor are shared by the first pixel and the second pixel.

17. The device of claim 9, wherein the peripheral region comprises a low power, high-speed, high-performance logic circuit.

18. The device of claim 9, wherein the first depth is between approximately 0.6 μm and 1 μm.

19. The device of claim 9, wherein the second depth is approximately 0.6 μm or less.

20. The device of claim 9, wherein the second trench isolation structure includes at least one of silicon dioxide and air.
